(19) United States
(12) Patent Application Publication
(10) Pub. No.: US 2026/0009546 A1
(43) Pub. Date: Jan. 8, 2026

(54) AN AIR-CONDITIONED TENT HOUSE FOR CHILDREN AND PET

(71) Applicant: Rongshen Huang, Foshan (CN)

(72) Inventor: Rongshen Huang, Foshan (CN)

(21) Appl. No.: 18/890,169

(22) Filed: Sep. 19, 2024

(30) Foreign Application Priority Data
Jul. 2, 2024 (CN) 202421551454.3

(51) Int. Cl. F24F 5/00; A01K 1/00

(52) U.S. Cl. CPC F24F 5/0042; A01K 1/0047; F24F 2221/17

(57) ABSTRACT

An air-conditioned tent house for children and pets including a children's pet house body and a multifunctional temperature regulating box, a connecting hole is provided on the house body, and the temperature regulating box is arranged on the house body, and the temperature regulating box comprises a box body. The box body including an insulation board, and a fan and a semiconductor cooling and heating plate are provided on the insulation board. The fan is provided on one side of the semiconductor cooling and heating plate, and heat sinks are connected to both sides of the semiconductor cooling and heating plate. The side wall of the box body is provided with an air inlet, a first air outlet and a second air outlet, and the second air outlet is connected to the inside of the house body through a connecting hole.

### CROSS-REFERENCE TO RELATED APPLICATIONS

This application claims priority to Chinese Patent Application No. 202421551454.3, filed on Jul. 2, 2024, which is hereby incorporated by reference in its entirety.

### TECHNICAL FIELD

The present application relates to a child or pet house, and in particular to a child or pet house with adjustable temperature.

### BACKGROUND

Tents or pet houses are now widely used, but these houses basically do not have temperature regulation functions. For example, in order to improve the temperature in the house, users often install fans in the house, which makes the use space in the house more limited, and fans are easy to accidentally injure users when used. As for pet houses, in order to improve the temperature in the pet house, some patents are now public, in which an air supply assembly is installed on the pet box body, and the air intake is controlled by moving the baffle to adjust the temperature in the pet box. The temperature regulation structure in this type of pet box is relatively complex, and the entire installation structure is relatively cumbersome, and the volume occupied is relatively large. Moreover, the function is single, with only temperature regulation function. When mosquitoes and sterilization are required for outdoor use, it cannot be met at the same time.

### SUMMARY

The purpose of the present disclosure is to provide an air-conditioned tent house for children and pets which can solve at least one of the above problems.

According to one aspect of the present disclosure, a children's pet air-conditioning tent house is provided, including a pet house body and a temperature regulating box. A connecting hole is provided on the pet house body, and a temperature regulating box is provided on the pet house body. The temperature regulating box includes a box body, a heat insulation board is provided on the box body, a fan and a semiconductor cooling and heating plate are provided on the heat insulation board, the fan is provided on one side of the semiconductor cooling and heating plate, and heat sinks are relatively connected on both sides of the semiconductor cooling and heating plate. An air inlet, a first air outlet and a second air outlet are provided on the side wall of the box body. The first air outlet and the second air outlet are respectively arranged on opposite sides of the box body. The air inlet corresponds to the fan. The first air outlet and the second air outlet both correspond to the air supply direction of the fan. The second air outlet is connected to the interior of the pet house through a connecting hole.

The beneficial effects of the present disclosure are as follows: by arranging a temperature regulating box on the pet house body, the cooling or heating gas can be introduced into the pet house body through the connecting hole through the semiconductor cooling and heating plate, thereby realizing the temperature regulation inside the pet house body and achieving the refrigeration or cooling effect; the temperature regulating box adopts a box body structure, which has a simple structure and is easy to install, does not occupy the space inside the pet house body, and is convenient for normal use by the pet.

As a preferred solution, the connecting hole is located on the side and/or top of the pet house body. Thus, it is convenient to install the temperature regulating box on the side or top of the pet house body.

As a preferred solution, an air-conditioned tent for children and pets further includes a dust cover, and the dust cover is disposed inside the connecting hole. Thus, by providing a dust cover, pet hair and the like can be effectively prevented from entering the temperature control box.

As a preferred solution, the outer periphery of the box body is provided with fixing holes, and the fixing holes correspond to the pet house body. Thus, by providing the fixing holes, it is convenient to fix the box body on the pet house body through the fixing holes, effectively preventing the box body from falling.

As a preferred solution, a first heat sink is connected to one side of the semiconductor cooling and heating plate, and a second heat sink is connected to the other side of the semiconductor cooling and heating plate. The first heat sink and the second heat sink are located on opposite sides of the heat insulation board. Thus, the first heat sink and the second heat sink can quickly dissipate the heat on both sides, accelerate the heat dissipation in the box, and facilitate the temperature regulation in the pet house.

As a preferred solution, the surface area of the first heat sink is greater than the surface area of the second heat sink, thereby further improving the heat dissipation effect of the first heat sink, thereby quickly adjusting the temperature on both sides of the partition.

As a preferred solution, the heat insulation board is provided with a mounting hole, and the heat insulation board and the semiconductor cooling and heating plate are connected through the mounting hole. Thus, by providing the mounting hole, the semiconductor cooling and heating plate is easily installed, and the cooling and heating temperatures are quickly transferred to the heat sinks on the corresponding sides.

As a preferred solution, the box body includes an upper cover and a lower cover, the inner side of the lower cover is provided with a plug hole, the inner side of the upper cover is provided with a plug column, and the plug column cooperates with the socket. Thus, the cooperation between the socket and the plug column facilitates the rapid assembly of the upper cover and the lower cover.

As a preferred solution, a positive and negative ion generator is provided on the box body, so that positive and negative ions for sterilization can be generated by the positive and negative ion generator, and at the same time, the positive and negative ions have the function of deodorization.

As a preferred solution, an insect repellent module is provided on the box body, including a heating module for heating insect repellent liquid, insect repellent tablets, etc., or an ultrasonic insect repellent module.

As a preferred solution, a charging interface is provided on the box body, and the semiconductor cooling and heating plate, fan, positive and negative ion generator, insect repellent electrical components, etc. are all electrically connected to the charging interface. Thus, by providing a charging interface, it is convenient for an external power source to power the corresponding components in the box body.

### BRIEF DESCRIPTION OF DRAWINGS

FIG. 1 is a schematic structural diagram of an air-conditioned tent house for children and pets according to the present invention;

FIG. 2 is a schematic structural diagram of a pet house body in an air-conditioned tent house for children and pets according to the present invention;

FIG. 3 is a schematic structural diagram of a temperature regulating box in an air-conditioned tent house for children and pets according to the present invention;

FIG. 4 is a schematic structural diagram of a temperature regulating box in an air-conditioned tent house for children and pets according to the present invention in an open state;

FIG. 5 is a schematic structural diagram of various structures on a heat insulation board in an air-conditioned tent house for children and pets according to the present invention;

FIG. 6 is a schematic structural diagram of a temperature regulating box portion of a children's and pets' air-conditioning tent house according to the present invention.

FIG. 7 is a schematic diagram of the foldable usage state structure of the children's pet air conditioning tent of the present invention

FIG. 8 is a schematic diagram of the usage state structure of the detachable mode of the children's pet air conditioning tent of the present invention.

### DESCRIPTION OF EMBODIMENTS

The following is a further detailed description of the present disclosure in conjunction with the accompanying drawings.

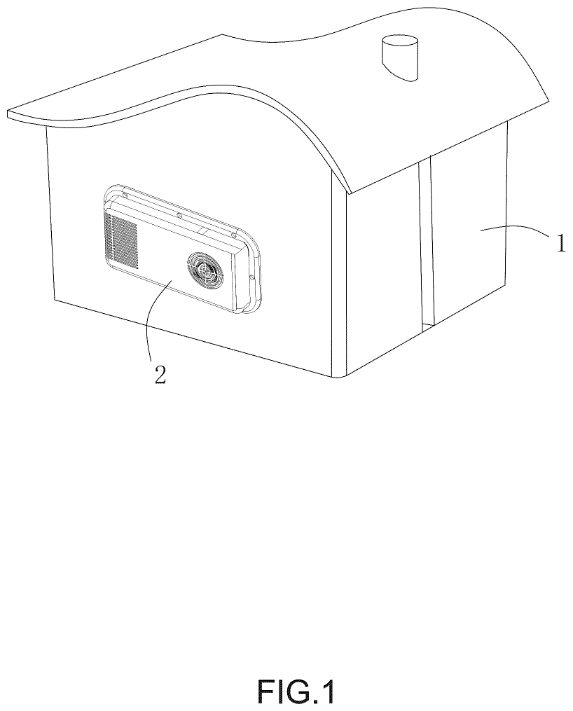

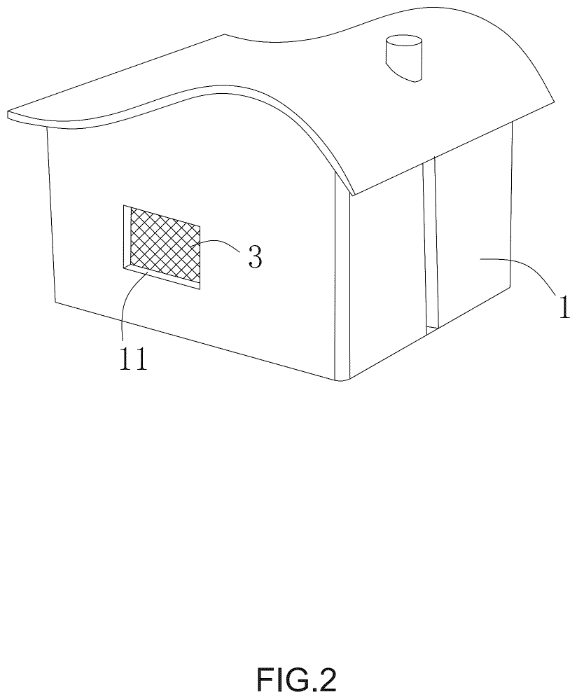

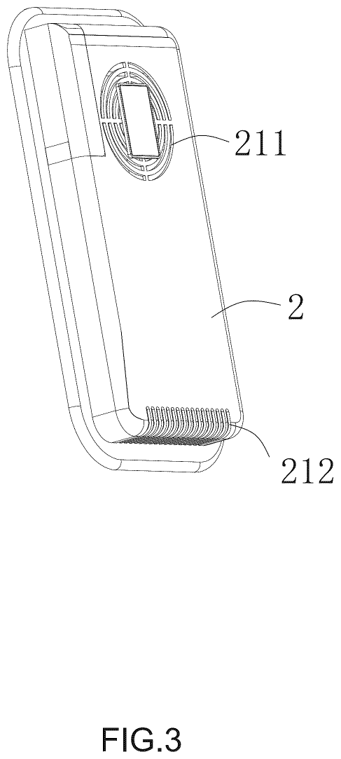

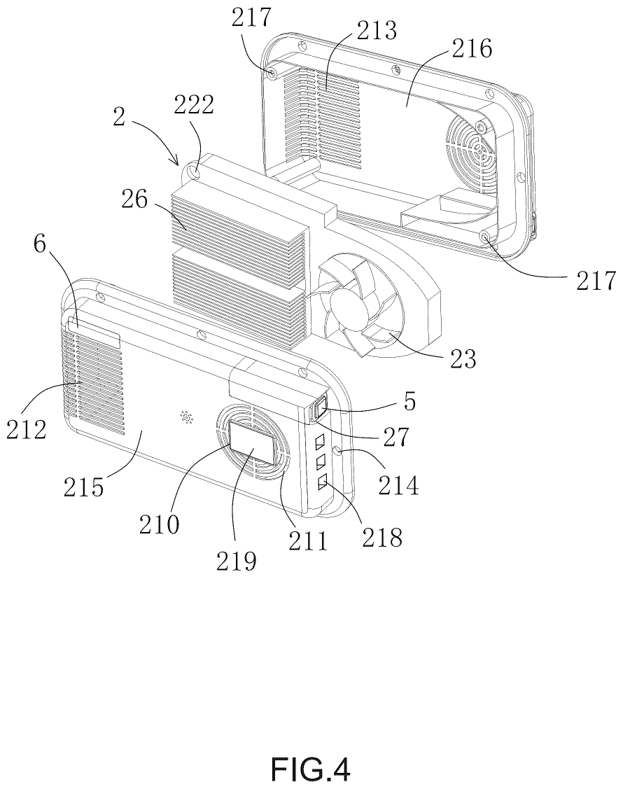

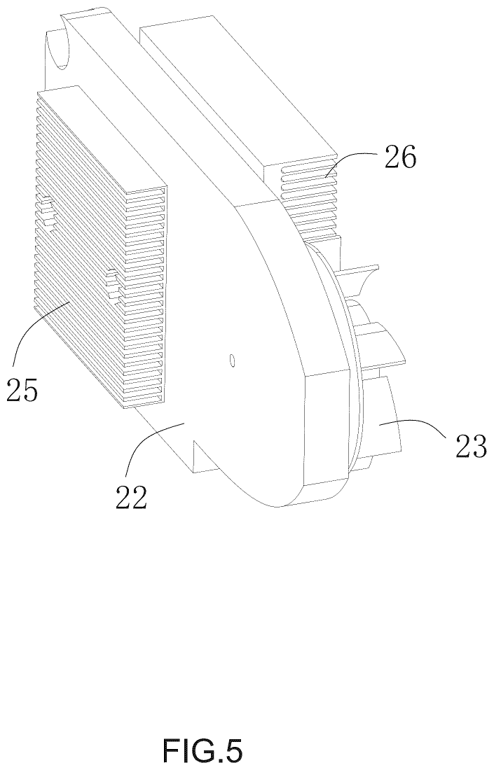

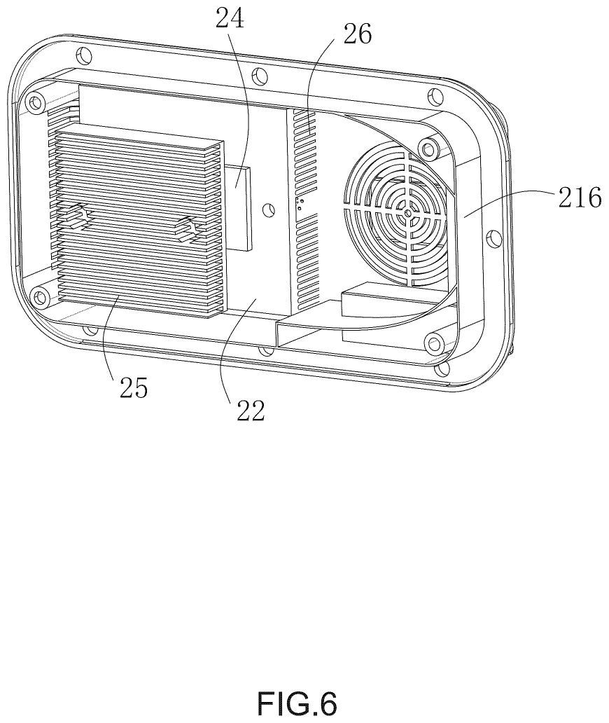

Referring to FIG. 1 to 6, the air-conditioned tent house for children and pets comprises a pet house body 1 and a temperature regulating box 2, wherein a connecting hole 11 is provided on the pet house body 1, and the temperature regulating box 2 is arranged on the pet house body 1, and the temperature regulating box 2 comprises a box body 21, wherein a heat insulating board 22 is provided inside the box body 21, and a fan 23 and a semiconductor cooling and heating plate 24 are provided on the heat insulating board 22, and the fan 23 is provided on one side of the semiconductor cooling and heating plate 24, and heat sinks are connected to both sides of the semiconductor cooling and heating plate 24, and an air inlet 211, a first air outlet 212 and a second air outlet 213 are provided on the side wall of the box body 21, and the first air outlet 212 and the second air outlet 213 are respectively provided on opposite sides of the box body 21, and the air inlet 211 corresponds to the fan 23, and the first air outlet 212 and the second air outlet 213 both correspond to the air supply direction of the fan 23, and the second air outlet 213 is connected to the inside of the pet house body 1 through the connecting hole 11. The air supply direction of the fan 23 refers to the direction in which the air flow is blown toward the heat sink 22 when the fan 21 rotates. By providing the air inlet 211, it is convenient for external air to enter the box body 21.

By providing the heat insulation board 22, the heat emitted by the semiconductor cooling and heating plate 24 to both sides will not affect each other, so as to realize the cooling or heating effect of the pet house. The air-conditioned tent house for children and pets can be used in structures such as pet houses and tents, has a simple structure, a small size, and is easy to carry.

When the temperature in the pet house body 1 is high, the refrigerated air generated by the semiconductor cooling and heating plate 24, under the action of the fan 23, passes through the second air outlet 213 to the connecting hole 11 and enters the pet house body 1 to cool the pet house body 1.

The connecting hole 11 is located on the side and/or top of the pet house body 1. In specific use, a boss can be formed on one side of the box body 21 where the second air outlet 213 is opened, and the second air outlet 213 is located on the boss. During installation, the boss is embedded in the connecting hole 11, so that the cooling or heating air flowing out through the second air outlet 213 directly enters the pet house body 1, and the installation and positioning are convenient.

The air-conditioned tent house for children and pets also includes a dust cover 3, which is arranged on the inner side of the connecting hole 11. The dust cover 3 can be fixed on the inner wall of the pet house body 1 by gluing, and the operator can directly remove the hair and the like on the dust cover 3 through the entrance and exit of the pet. By providing the dust cover 3, the pet hair can be prevented from entering the temperature regulating box 2 to a certain extent.

The outer periphery of the box body 21 is provided with fixing holes 214, and the fixing holes 214 correspond to the pet house body 1. Specifically, when the temperature regulating box 2 needs to be fixed on the pet house body 1, it can be fixed by passing bolts through the fixing holes 214 to achieve the fixation of the entire box body 21; when the pet house body 1 needs to be cleaned, the bolts can be loosened and the box body 21 can be removed, which is convenient for disassembly and assembly.

A first heat sink 25 is connected to one side of the semiconductor cooling and heating plate 24, and a second heat sink 26 is connected to the other side of the semiconductor cooling and heating plate 24. The first heat sink 25 and the second heat sink 26 are respectively located on opposite sides of the heat insulation board 22. Among them, the surface area of the first heat sink 25 is greater than the surface area of the second heat sink 26. When the side where the semiconductor cooling and heating plate 24 is connected to the second heat sink 26 is the cooling surface, hot air is blown out from the first air outlet 212, and cold air is discharged from the second air outlet 213 on the other side of the box body. On the contrary, hot air is discharged from the second air outlet 213, and cold air is blown out from the first air outlet 212, thereby realizing continuous cooling or heating functions, and the temperature on both sides of the box body 21 can be quickly adjusted. Thereby, it is convenient to cool or heat the inside of the pet house body 1 according to the actual temperature, meeting the actual use requirements.

The heat insulation board 22 is provided with a mounting hole 221, and the heat insulation board 22 and the semiconductor cooling and heating plate 24 are connected through the mounting hole 221. The semiconductor cooling and heating plate 24 is fixed in the mounting hole 221 (blocked by the semiconductor cooling and heating plate 24 in the figure, not shown) by bonding, so that the semiconductor cooling and heating plate 24 is fixed.

The box body 21 includes an upper cover 215 and a lower cover 216. The lower cover 216 has an plug hole 217 formed on its inner side. The upper cover 215 has an insert column formed on its inner side, which matches the plug hole 217. During actual assembly, a through hole 222 is formed on the heat insulation board 22. Therefore, when the upper cover 215 and the lower cover 216 are assembled, the insert column first passes through the through hole and then is inserted into the plug hole 217, so that the heat insulation board 22 can be fixed in the box body 21.

Inside the box body 21, during actual assembly, electronic components such as positive and negative ion generators and insect repellent modules (not shown in the figure) can be installed in the empty space between the heat insulation board 22 or the upper cover 215 and the lower cover 216.

The box body 21 is provided with a charging interface 218 (not shown in the figure), and the semiconductor cooling and heating plate 24 and the fan 23 are electrically connected to the charging interface 218. In order to conveniently power the electronic components in the box body 21, a rechargeable battery can be installed in the box body 21; the rechargeable battery is charged through the charging interface 218. Among them, the charging interface can be an interface such as Type-C or USB interface, or several interfaces coexist, so as to realize the functions of power supply for external devices, data transmission, etc. An external lighting lamp can be connected.

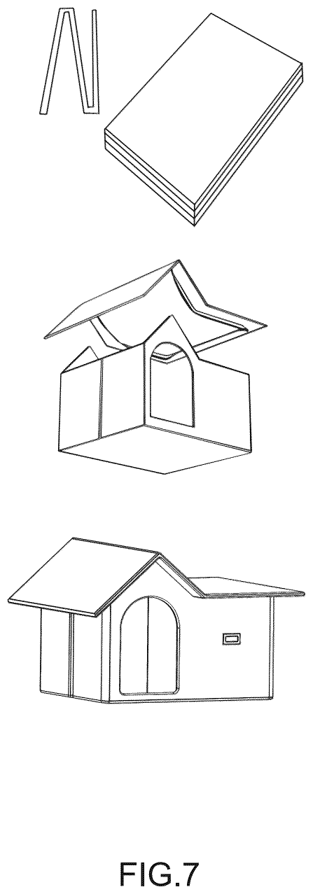

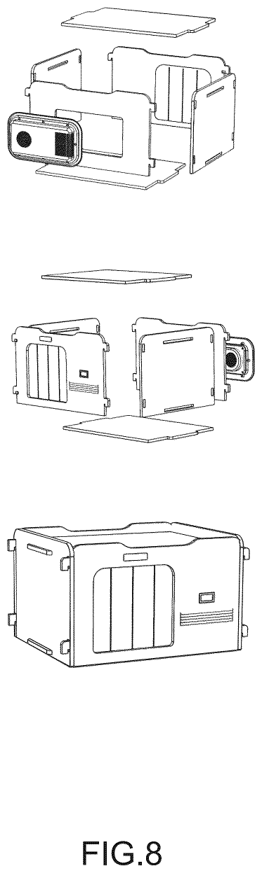

The house is a foldable tent or hardboard disassembly structure, which is easy to carry and reassemble (see FIGS. 7 and 8).

The above are only preferred implementations of the present invention. It should be pointed out that, for ordinary technicians in this field, several modifications and improvements can be made without departing from the creative concept of the present invention, which all belong to the protection scope of the present invention.

What is claimed is:

1. An air-conditioned tent house for children and pets, wherein it comprises a pet house body and a temperature regulating box, wherein the pet house body is provided with a connecting hole, the temperature regulating box is arranged on the pet house body, the temperature regulating box comprises a box body, a heat insulation board is arranged in the box body, a fan and a semiconductor cooling and heating plate are arranged on the heat insulation board, the fan is arranged on one side of the semiconductor cooling and heating plate, and the semiconductor cooling and heating plate is provided on the heat insulation board are connected to heat sinks on both sides thereof; an air inlet, a first air outlet and a second air outlet are provided on the side walls of the box body; the first air outlet and the second air outlet are respectively arranged on opposite sides of the box body; the air inlet corresponds to the fan; the first air outlet and the second air outlet both correspond to the air supply direction of the fan; the second air outlet is connected to the interior of the pet house body through the connecting hole.

2. The air-conditioned tent house for children and pets according to claim 1, wherein the connecting hole is located on the side and/or top of the pet house body.

3. The air-conditioned tent house for children and pets according to claim 2, wherein it also includes a dust cover, and the dust cover is located inside the connecting hole.

4. The air-conditioned tent house for children and pets according to claim 3, wherein a fixing hole is provided on the outer periphery of the box body, and the fixing hole corresponds to the pet house body.

5. The air-conditioned tent house for children and pets according to claim 2, wherein a first heat sink is connected to one side of the semiconductor cooling and heating plate, and a second heat sink is connected to the other side of the semiconductor cooling and heating plate, and the first heat sink and the second heat sink are respectively located on opposite sides of the insulation board.

6. The air-conditioned tent house for children and pets according to claim 5, wherein the surface area of the first heat sink is greater than the surface area of the second heat sink.

7. The air-conditioned tent house for children and pets according to claim 6, wherein a mounting hole is provided on the heat insulation board, and the heat insulation board and the semiconductor cooling and heating plate are connected through the mounting hole.

8. The air-conditioned tent house for children and pets according to claim 7, wherein the box body comprises an upper cover and a lower cover, a plug hole is provided on the inner side of the lower cover, and a plug column is provided on the inner side of the upper cover, and the plug column matches the plug hole.

9. The air-conditioned tent house for children and pets according to claim 8, wherein a charging interface is provided on the box body, and the semiconductor cooling and heating 10 plate and the fan are both electrically connected to the charging interface.

10. The air-conditioned tent house for children and pets according to claim 9, wherein the box body integrates positive and negative ion generators, mosquito repellent ultrasonic modules and heating modules, and can be directly connected to the system power supply circuit or externally connected to a charging interface for power supply.
